(19) United States
(12) Patent Application Publication
(10) Pub. No.: US 2017/0217007 A1
(43) Pub. Date: Aug. 3, 2017

(54) TOOTHBRUSH WITH PUSH-BACK REPLACEABLE BRUSH HEAD

(71) Applicant: SUBAYU INDUSTRIAL CO., LTD., NEW TAIPEI CITY (TW)

(72) Inventor: Shih-Hao CHEN, New Taipei City (TW)

(21) Appl. No.: 15/014,016

(22) Filed: Feb. 3, 2016

(51) Int. Cl. B25G 1/10; B25G 3/20; A46B 5/00

(52) U.S. Cl. CPC B25G 1/10; A46B 5/0095; B25G 3/20; A46B 2200/1066

(57) ABSTRACT

A toothbrush with a push-back replaceable brush head includes a handle portion, a handle front section moveable inserted into the handle portion and having a supporting platform, a push mechanism including a push plate and a locking plate stacked together and penetrating through the handle front section, the push plate and the locking plate secured onto the handle portion; a brush head replaceably installed on the supporting platform, another end of the locking plate locked onto the brush head and the handle front section; wherein the handle front section is pushed toward the handle portion to allow the locking plate, the handle front section and the brush head to release from locking while the push plate pushes the brush head away from the supporting platform. Therefore, the release of locking and disengagement of the brush head can be achieved at the same time to facilitate operations of the toothbrush.

### BACKGROUND OF THE INVENTION

Field of the Invention

The present invention is related to a toothbrush, in particular, to a toothbrush with push-back replaceable brush head.

Description of Related Art

For most of the toothbrushes currently available in the market, they are typically made of plastic materials, and their lifetimes are approximately three months. After the brush bristles on the toothbrush contact with the teeth for a period of time, it would cause a certain degree of wear out such that the performance of cleaning is reduced and is prone to the growth of bacteria; therefore, it must be discarded after a period of time, which causes not only the waste of resources but also the concerns of endangering the environmental protection.

To effectively improve the aforementioned problem, manufacturers in the industry then provides the design of toothbrushes with replaceable brush heads, which mainly comprises a handle portion and a brush head connected to the handle portion. The brush head comprises a base connected to the handle portion and a brush plate disposed with brush bristles thereon; wherein the base and the brush plate respectively include an insertion slot and a insertion portion in order to allow the brush plate with brush bristles to be inserted into the base such that a toothbrush with a replaceable brush head can be constructed.

However, for the toothbrush with the replaceable brush head, the following problem is still found during the actual process of use. Since it uses the insertion slot for securement, after a period of time of use, the insertion hole tends to becomes loose such that the condition of falling off is likely to occur.

### SUMMARY OF THE INVENTION

An objective of the present invention is to provide a toothbrush with a push-back replaceable brush head, which allows the handle front section to be pushed into the handle portion such that it is able to achieve the release of the locking and the retraction for disengagement of the brush head at the same time; therefore, the convenience of the operation of the toothbrush is further increased.

To achieve the aforementioned objective, the present invention provides a toothbrush with a push-back replaceable brush head, comprising a handle portion, a handle front section, a push mechanism and a brush head. The handle front section is moveable inserted into the handle portion, and the handle front section includes a supporting platform. The push mechanism comprises a push plate and a locking plate stacked onto each other and penetrating through the handle front section; one end of the push plate and the locking plate is secured onto the handle portion. The brush head is replaceably installed on the supporting platform; another end of the locking plate locked onto the brush head and the handle front section. Wherein, the handle front section is pushed toward a direction of the handle portion in order to allow the locking plate, the handle front section and the brush head to release from locking while allowing the push plate to push the brush head toward a direction away from the supporting platform.

The present invention is also of the following effects. The locking effect can be achieved by the cooperation among the locking block, through slot and latch slot of the rotating arm. The use of the locking edge of the handle portion and the locking block of the handle front section are locked onto each other in order to achieve the effect of restriction therebetween. With the assistance of the elastic locking hooks pushed by the slanted push surface, the effect of effort saving can be achieved. Each one of the elastic hooks are used for locking onto the lateral slot and the locking slot; therefore, when the brush bristles of the brush head move up and down as well as left and right on the human teeth for cleaning thereof, the brush head can be stably hold on the supporting platform without any occurrences of loose or disengagement thereof.

### BRIEF DESCRIPTION OF DRAWING

FIG. 1 is a perspective outer view of the toothbrush with a push-back replaceable brush head of the present invention;

FIG. 2 is an exploded view of the toothbrush with a push-back replaceable brush head of the present invention;

FIG. 3 is another exploded view of the toothbrush with a push-back replaceable brush head of the present invention from another viewing angle;

FIG. 4 is an assembly cross sectional view of the toothbrush with a push-back replaceable brush head of the present invention;

FIG. 5 is a partial cross sectional view of the assembly of the push mechanism and the brush head of the present invention;

FIG. 6 is a cross sectional view showing a state of use of the toothbrush with a push-back replaceable brush head of the present invention; and

FIG. 7 is another cross sectional view showing a state of use of the toothbrush with a push-back replaceable brush head of the present invention.

FIG. 8 is a perspective outer view of another embodiment of the present invention.

### DETAILED DESCRIPTION OF THE INVENTION

The following provides a detailed description on the embodiments and technical content related to the present invention along with the accompanied drawings. However, it shall be understood that the accompanied drawings are provided for illustration purposes only and shall not be treated as limitations of the present invention.

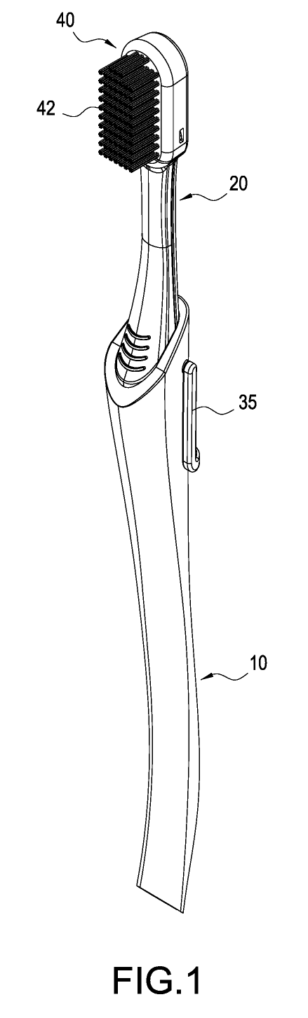

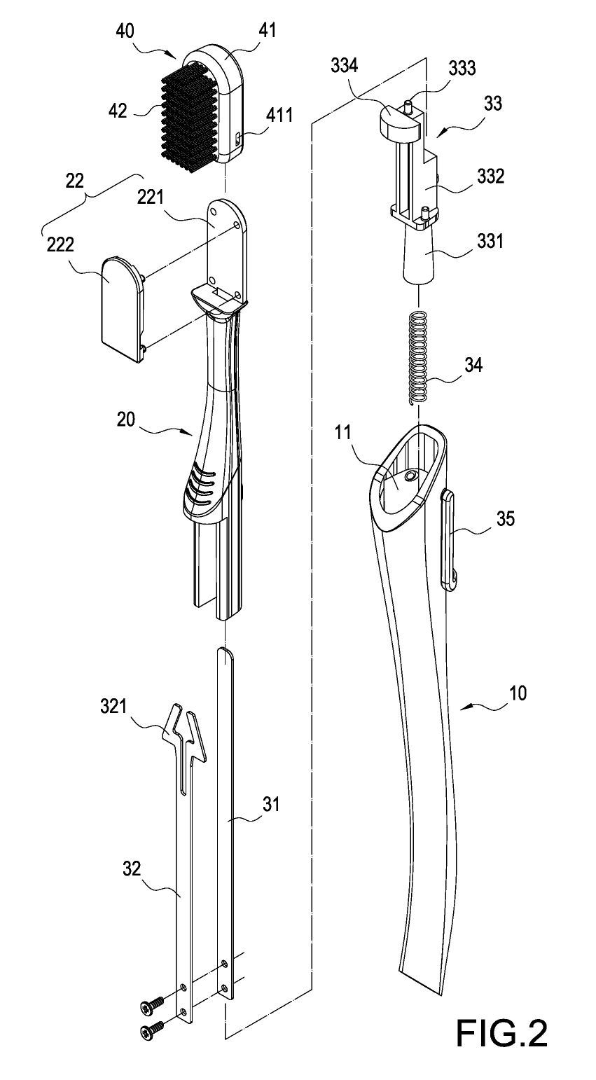

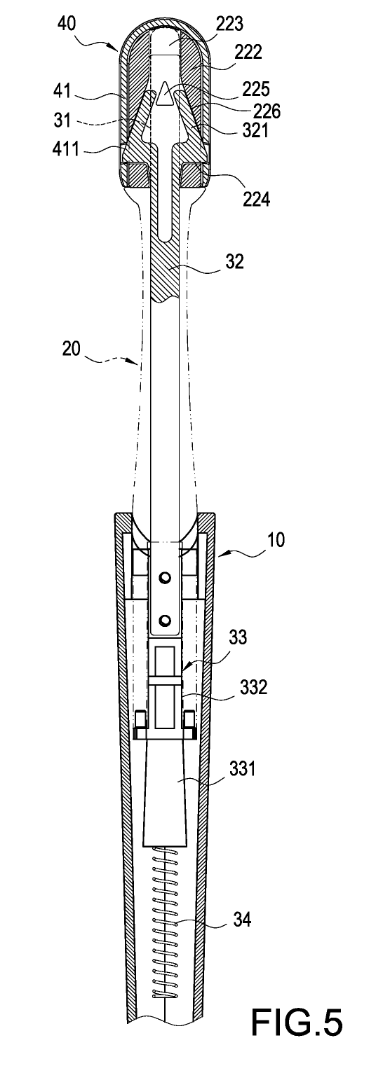

Please refer to FIG. 1 to FIG. 5. The present invention provides a toothbrush with a push-back replaceable brush head, mainly comprising a handle portion 10 a handle front section 20, a push mechanism 30 and a brush head 40.

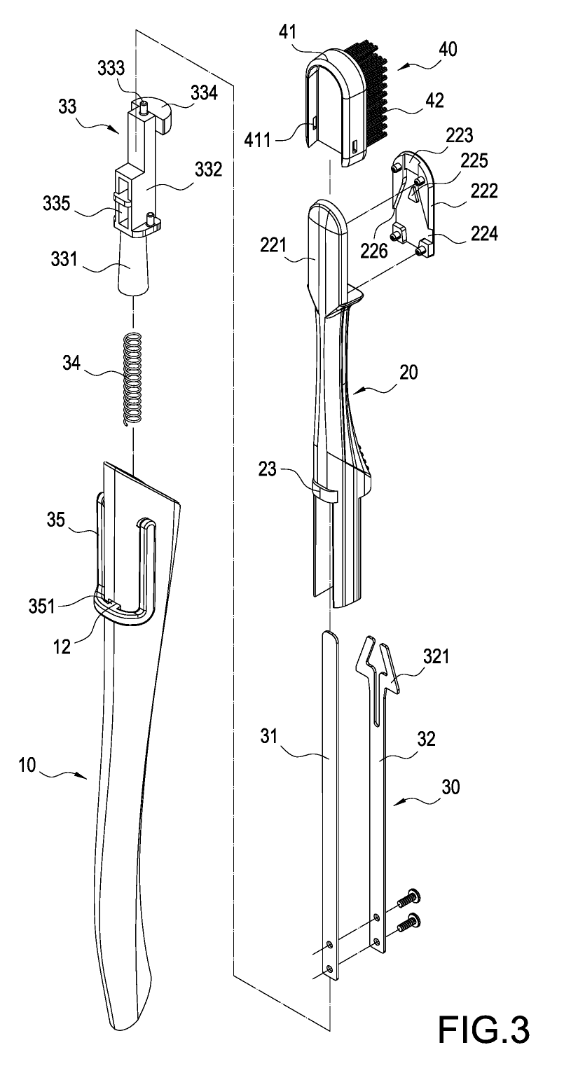

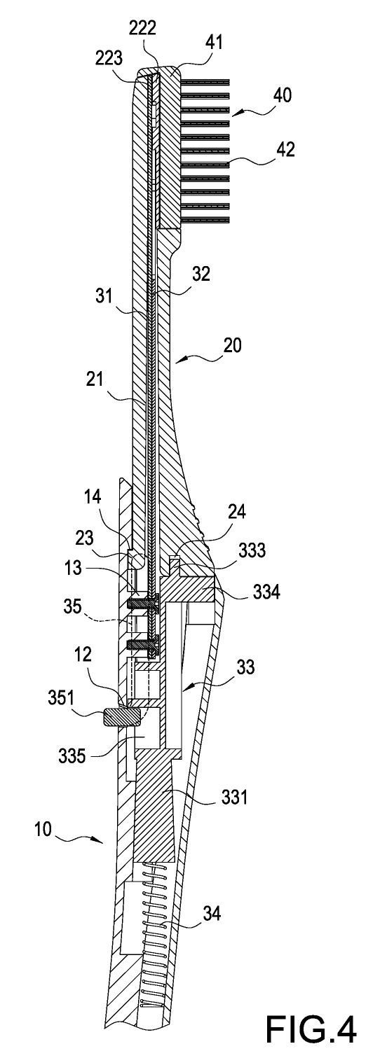

The handle portion 10 can be an elongated body made of a plastic material. A center location of the front side of the handle portion 10 includes an accommodating chamber 11, and a through slot 12 connected to the accommodating chamber 11 is formed at the front side of the rear surface of the handle portion 10 (as shown in FIG. 3). In addition, the top of the inner wall of the accommodating chamber 11 includes a plurality of threaded columns 13 and a locking edge 14 formed thereon and arranged spaced apart from each other (as shown in FIG. 4).

The handle front section 20 is moveably inserted into the accommodating chamber 11 of the handle portion 10 and is formed at the front side of the handle portion 10. The handle front section 20 can also be made of a plastic material, and it includes a through hole 21 formed along the length direction and configured to allow the through hole to penetrate in a front to rear manner (as shown in FIG. 4). In addition, the front side of the handle front section 20 includes a supporting platform 22. The supporting platform 22 comprises a lower base board 221 and an upper base board 222 configured to cover and secure onto the lower base board 221 correspondingly. The end surface of the upper base board 222 facing toward the lower base board 221 includes a longitudinal slot 223 and a lateral slot 224 connected to the longitudinal slot formed thereon. Furthermore, the middle section of the longitudinal slot 223 includes a triangular block 225 protruded therefrom, and a slanted push surface 226 is respectively formed along two sides of the triangular block 225 to the location of the lateral slot 224 (as shown in FIG. 3). Moreover, a latch block 23 is formed at the surface of the rear side of the handle front section 20, and such latch block 23 is locked onto the aforementioned locking edge 14 with each other. In addition, the rear side of the handle front section 20 includes an insertion hole 24 formed thereon (as shown in the drawings).

The push mechanism 30 mainly comprises a push plate 31, a locking plate 32, a pressing member 33, a compression spring 34 and a rotating arm 35. The push plate 31 and the locking plate 32 are elongated plates made of a metal material. The front end of the locking plate 32 includes a pair of elastic hooks 321 formed thereon, and each one of the elastic hooks 321 is formed of a triangle shape. The locking plate 32 is stacked on top of the push plate 31 and is secured onto the aforementioned each one of the threaded columns 13 via screw fastening units of, such as, screws. The front section of the push plate 31 and each one of the elastic hooks 321 are received inside the aforementioned longitudinal slot 223 and the lateral slot 224. Each one of the elastic hooks 321 is formed between the aforementioned triangular block 225 and each one of the slanted push surfaces 226, and a hooking end of each one of the elastic hooks 321 exposes to the external of the lateral slot 224.

The pressing member 33 and the compression spring 34 are serially connected to each other and received at the bottom section of the aforementioned accommodating chamber 11. The pressing member 33 comprises a circular shaft section 331, a locking section 332 extended upward from the top end of the circular shaft section 331, a protruding column 333 extended upward from the top end of the locking section 332 and a semi-circular block 334 extended toward the front side from the top portion of the locking section 332. The compression spring 34 is clamped between the circular shaft section 331 and the accommodating chamber 11 of the handle portion 10. The protruding column 333 penetrates through the insertion hole 24. The semi-circular block 334 is attached onto the lower end portion of the handle front section 20. The locking section 332 includes a latch slot 335. The rotating arm 35 is pivotally attached to the handle portion 10, and the rotating arm 35 includes a locking block 351 penetrating through the aforementioned through slot 12 in order to lock onto the latch slot 335 (as shown in FIG. 4).

The brush head 40 includes a brush head base 41 and a plurality of brush bristles 42 disposed on the brush head base 41. The brush head base 41 is replaceably installed on the aforementioned supporting platform 22. The two sides of the brush head base 41 respectively include a locking slot 411 formed at a location corresponding to the aforementioned lateral slot 224. Each one of the aforementioned elastic hooks 321 is locked inside the lateral slot 224 and the locking slot 411 for securement thereof such that when the user holds the handle portion 10 and uses the brush bristles 42 of the brush head 40 to move up and down as well as left and right on the human teeth for cleaning thereof, the brush head 40 can be stably hold on the supporting platform 22 without any unfavorable occurrences of loose or disengagement; therefore, it further increase the safety of the use thereof.

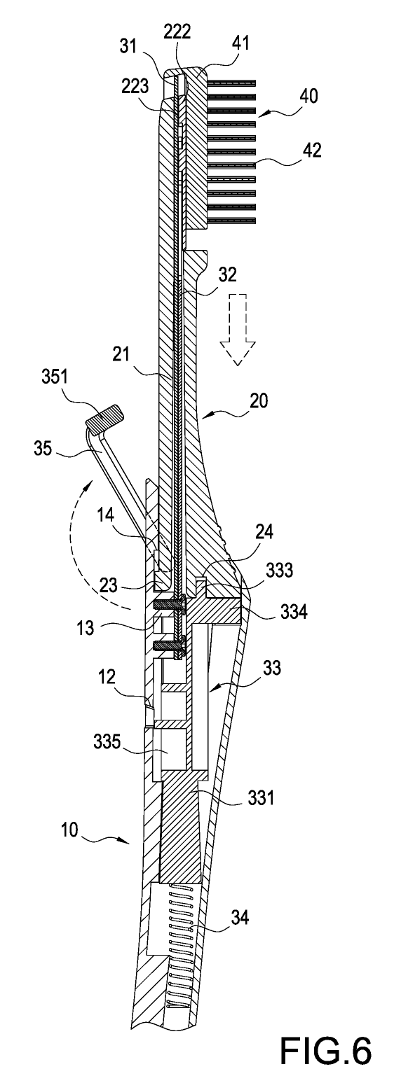

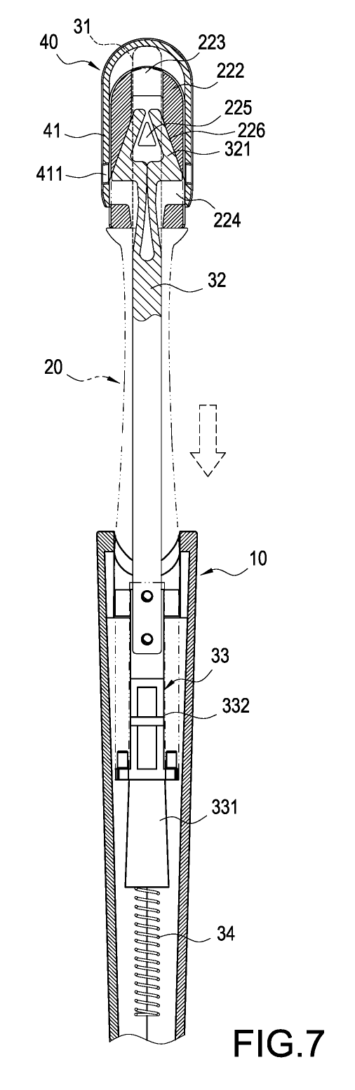

Please refer to FIG. 6 and FIG. 7. During the use of the present invention, the rotating arm 35 is rotated upward with its pivotal attachment area as the rotational center, and the locking block 351 is retracted from the latch slot 335 and the through slot 12, followed by pushing the handle front section 20 toward the direction of the internal of the accommodating chamber 11 of the handle portion 10. At this time, since the push plate 31 and the locking plate 32 are stationary without movements while the supporting platform 22 moves downward and uses its slanted push surface 226 to push against each one of the elastic hooks 321 to retract toward the inner side thereof, the hooking end of each one of the elastic hooks 321 is moved away from the locking slot 411 and the lateral slot 224 in order to release the locking on the brush head base 41 and the supporting platform 22. In addition, the top edge of the brush head base 41 is also pushed by the push plate 31 such that it allows the brush head base 41 to retract and move toward a direction away from the supporting platform 22.

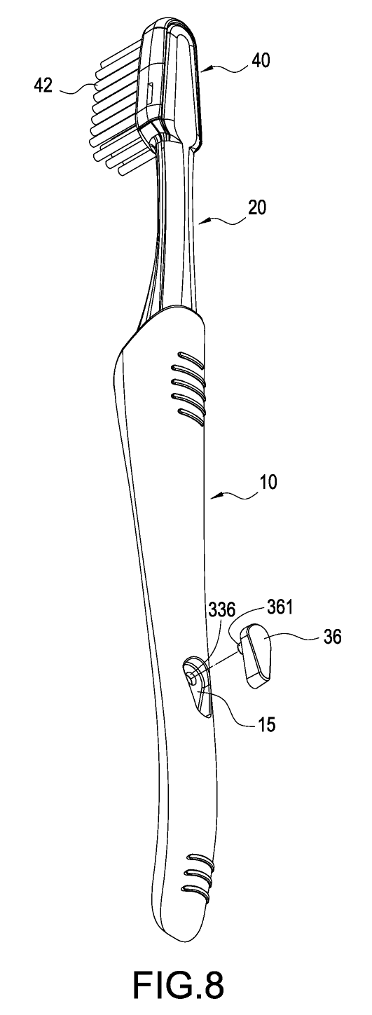

Please refer to FIG. 8, for the toothbrush with a push-back replaceable brush head of the present invention, in addition to the aforementioned embodiments, it can also be provided with a cavity 15 formed at the lower portion of the rear side of the handle portion 10 and connected to the accommodating chamber 11, and a locking hole 336 is formed on the circular shaft section 331 of the pressing member 33. In this embodiment, a cover member 36 is used for replacing the rotating arm 35 of the aforementioned embodiment, and the cover member 36 includes a positioning column 361. After the handle front section 20 is pressed into the accommodating chamber 11 of the handle portion 10, the locking hole 336 is then located inside the cavity 15; at this time, the cover member 36 is inserted into the cavity 15 correspondingly in order to allow the positioning column 361 to insert into the locking hole 336; therefore, the assembly and positioning of the handle front section 20 and the handle portion 10 are achieved.

In view of the above, the toothbrush with a push-back replaceable brush head of the present invention is able to achieve the expected objectives of use while overcoming the drawbacks of the prior arts, which is of novelty and inventive step as well as complies with the requirement for the application of an invention patent. The present invention is, therefore, legitimately applied and seeks for the grant of the patent right for protection of the invention and the right of the inventor.

What is claimed is:

1. A toothbrush with a push-back replaceable brush head, comprising:
a handle portion;
a handle front section moveable inserted into the handle portion, the handle front section having a supporting platform;
a push mechanism comprising a push plate and a locking plate stacked onto each other and penetrating through the handle front section, one end of the push plate and the locking plate secured onto the handle portion; and
a brush head replaceably installed on the supporting platform, another end of the locking plate locked onto the brush head and the handle front section;
wherein the handle front section is pushed toward a direction of the handle portion in order to allow the locking plate, the handle front section and the brush head to release from locking while allowing the push plate to push the brush head toward a direction away from the supporting platform.

2. The toothbrush with a push-back replaceable brush head according to claim 1, wherein the handle portion includes an accommodating chamber, the push mechanism further comprises a pressing member and a compression spring serially connected to the pressing member, the pressing member and the compression spring are received inside the chamber and elastically clamped between the handle front section and the handle portion.

3. The toothbrush with a push-back replaceable brush head according to claim 2, wherein the handle portion includes a through slot connected to the chamber, the push mechanism further comprises a rotating arm pivotally attached to the handle portion, the pressing member includes a latch slot, the rotating arm includes a locking block penetrating through the through slot in order to lock onto the latch slot.

4. The toothbrush with a push-back replaceable brush head according to claim 2, wherein the accommodating chamber of the handle portion includes a threaded column, the push plate and the locking plate penetrate to lock onto the threaded column via a screw fastening unit.

5. The toothbrush with a push-back replaceable brush head according to claim 2, wherein the accommodating chamber of the handle portion includes a locking edge, a rear side of the handle front section includes a latch block for latching onto the locking edge with each other.

6. The toothbrush with a push-back replaceable brush head according to claim 2, wherein the handle front section includes an insertion hole; the pressing member comprises a circular shaft section, a locking section extended from the circular shaft section, a protruding column extended from the locking section; the circular shaft section elastically abuts against the compression spring, and the protruding column is inserted into the insertion hole correspondingly.

7. The toothbrush with a push-back replaceable brush head according to claim 2, wherein a rear side of the handle portion includes a cavity formed to connect to the accommodating chamber; the pressing member includes a locking hole formed thereon; the push mechanism further comprises a cover member, the cover member includes a positioning column; the cover member is inserted into the cavity correspondingly in order to allow the positioning column to insert into the locking hole for positioning.

8. The toothbrush with a push-back replaceable brush head according to claim 1, wherein the handle front section includes a through hole; the locking plate and the push plate penetrate through the through hole to reach the supporting platform.

9. The toothbrush with a push-back replaceable brush head according to claim 8, wherein the supporting platform comprises a lower base board and an upper base board configured to attach onto the lower base board correspondingly; the upper base board includes a longitudinal slot and a lateral slot connected to the longitudinal slot; an end portion of the locking plate includes a pair of elastic hooks formed thereon; a front section and each one of the elastic hooks of the push plate are received inside the longitudinal slot and the lateral slot.

10. The toothbrush with a push-back replaceable brush head according to claim 9, wherein the longitudinal slot includes a triangular block protruded outward therefrom; a slanted push surface is respectively formed along two sides of the triangular block to the lateral slot; each one of the elastic hooks is respectively formed between the triangular block and the slanted push surface.

11. The toothbrush with a push-back replaceable brush head according to claim 10, wherein the brush head includes a brush head base; the brush head base includes a pair of locking slots, and a hooking end of each one of the elastic hooks exposes out of the lateral slot to lock onto each one of the locking slots.
